(19) United States
(12) Patent Application Publication
(10) Pub. No.: US 2013/0080235 A1
(43) Pub. Date: Mar. 28, 2013

(54) SYSTEM AND METHOD FOR JOINT USE OF GIFT CODES AND COUPON CODES

(71) Applicant: GiftCodes.com, LLC, Pittsburgh, PA (US)

(72) Inventor: Jason Wolfe, Sewickley, PA (US)

(73) Assignee: GiftCodes.com, LLC, Pittsburgh, PA (US)

(21) Appl. No.: 13/630,350

(22) Filed: Sep. 28, 2012

Related U.S. Application Data
(60) Provisional application No. 61/540,225, filed on Sep. 28, 2011.

(51) Int. Cl. G06Q 30/02

(52) U.S. Cl. 705/14.26

(57) ABSTRACT

Systems, methods, and non-transitory computer-readable storage media for joint use of gift codes and coupon codes. This technology can provide a way to use both a gift code and a coupon code in a same transaction, to discover corresponding codes for a given code, and to easily complete purchases using a gift code and a coupon code. The system identifies a companion code associated with a first value, wherein the companion code is at least one of a deal code, a discount code, and a coupon code. The system identifies a gift code associated with a second value, wherein the companion code, when used to make a purchase in combination with the gift code, provides a discount. The system offers the gift code for sale, and, upon a user purchasing the gift code, transmits the gift code to the user for combined use with the companion code.

### PRIORITY CLAIM

The present application claims priority to U.S. Provisional Application No. 61/540,225, filed on Sep. 28, 2011, the content of which are incorporated herein by reference.

### BACKGROUND

1. Technical Field

The present disclosure relates to gift codes and coupon codes and more specifically to joint uses of coupon codes and gift codes.

2. Introduction

Coupon websites offer coupon codes which users search for and can copy and paste into online shopping carts at checkout to obtain a discount. Users browse for coupons from specific retailers or for specific items because they want to save money. Thus, any way to maximize the amount saved for a particular purchase is very attractive to this demographic. Certain coupon codes can be stacked with others to increase savings on a particular purchase, but other coupon codes are not stackable. Users are looking for options to save more money when making purchases, thus coupon websites and other entities need to find more ways to allow users to save on purchases.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A prepaid gift account is an arrangement under which one or more persons acting together provide an prepaid gift account holder with access to funds or the value of funds that have been paid in advance and can be retrieved or transferred at some point in the future through an electronic device or vehicle, such as a card, code, electronic serial number, mobile identification number, or personal identification number. Prepaid gift accounts can be issued as physical cards or as an account number delivered to the prepaid account holder via text message, email or as data displayed on an application residing on a mobile computing device such as a mobile telecommunications device, a mobile computing device such as a laptop computer, smart phone or tablet computer or a non-mobile computer device such as a personal computer system, personal gaming system or satellite or cable television system. Prepaid gift accounts can be closed loop, meaning that the value represented by the prepaid gift account is a valid form of payment at a closed set of retailers. A gift code is a prepaid gift account number, a code, string of characters, and/or other symbol that a user can provide in a checkout process to apply the value of funds in a prepaid gift account or a credit amount to a purchase. A coupon code is a code, string of characters, and/or other symbol that a user can provide to receive a discount on a purchase. A coupon code can be thought of as an electronic analog to a traditional paper coupon presented at a point of sale. A system can provide and/or enter a gift code and/or coupon code on behalf of a user.

The system disclosed herein is a way to use both a gift code and a coupon code in a same transaction, to discover corresponding codes for a given code, and to easily complete purchases using a gift code and a coupon code. For example, Tom receives a gift code. The website or manager that manages his gift code can also display coupon codes that match the gift code. For example, if the gift code is valid for a particular merchant, the website or manager can display coupon codes that are also valid for that merchant. In one embodiment, Tom can manually copy and paste the gift code and the coupon code into a merchant checkout process. In another embodiment, the website can combine the two codes into a single code for use at checkout. In yet another embodiment, the website can automatically enter, notify, or otherwise provide the gift code and the coupon code to a merchant system on behalf of Tom. For example, Tom can click to accept the gift code and coupon code combination, navigate directly to the merchant website to purchase an item, and the merchant website can automatically populate the gift code and coupon code fields based on instructions from the system on behalf of Tom. Thus, Tom can simply check out and obtain the discount provided by the coupon code and gift code combination.

Disclosed are systems, methods, and non-transitory computer-readable storage media for combining a gift code and a coupon code. A system practicing the method receives a user gift code having an associated first value and a second code having an associated second value, the second code being at least one of a deal code, a discount code, and a coupon code. Then, the system combines the first value with the second value to yield a third code that can be used for a purchase. Optionally, the third code is based on a set of combining rules governing how the system combines the gift code and the coupon code.

In another embodiment, the system presents on a display a coupon code for purchase by a user and an indication of an option to add a gift code to a purchase by the user of the coupon code, receives a selection from the user to purchase the coupon code and the gift code, and combines the coupon code and the gift code to yield a third code.

In yet another embodiment, the system identifies a coupon code being offered to a user and a gift code that corresponds to the coupon code and which can be used with the coupon code, and indicates to the user that the gift code exists. The system can present an offer to the user to use the coupon code and gift code simultaneously for a same transaction, either as a free or purchased service. The system can automatically apply, on behalf of the user, the coupon code and the gift code to a purchase. The system can present to the user the coupon code and gift code for application to a purchase. For example, the system can copy and paste the coupon code and gift code into an online cart at checkout.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a first example system architecture;

FIG. 3 illustrates a second example system architecture;

FIG. 4 illustrates a first example screenshot;

FIG. 5 illustrates a second example screenshot; and

FIG. 6 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

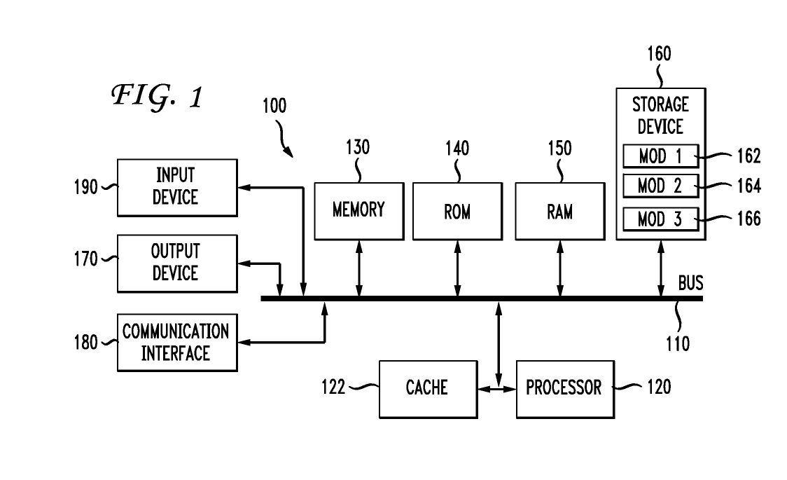

The present disclosure addresses the need in the art for joint uses of coupon codes and gift codes. A system, method and non-transitory computer-readable media are disclosed which combine a gift code and a coupon code. A brief introductory description of a basic general purpose system or computing device in FIG. 1, which can be employed to practice the concepts, is disclosed herein. A more detailed description of combining a gift code and a coupon code, including variations and examples, will then follow. These variations shall be discussed herein as the various embodiments are set forth. The disclosure now turns to FIG. 1.

With reference to FIG. 1, an exemplary system includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The computing device 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The computing device 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of coupon codes and gift codes.

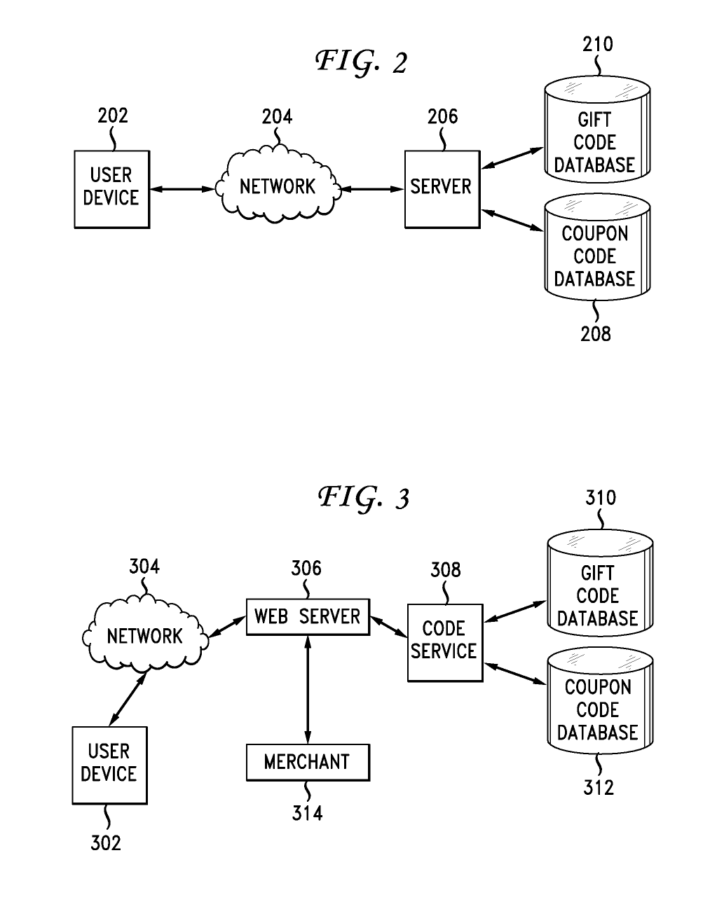

FIG. 2 illustrates a first example system architecture. The principles set forth herein can be applied to local area networks, intranets, home networks, corporate networks, and virtually any other form of network. In this architecture, a user device 202 communicates, via a network 204, with a server 206. A user device can be any device capable of sending and receiving information, such as a smartphone, tablet, laptop, desktop, etc. The server 206 can be a web server or any other server that provides data to the user device 202 regarding coupon codes from a coupon code database 208. When the server 206 identifies a coupon code to present to the user, the server can identify a corresponding gift code, from a gift code database 210, which can be used with the coupon code. The server 206 can present the gift code and coupon code to the user, which the user can then copy and paste or manually enter into a checkout process to obtain a discount associated with the coupon code and a value associated with the gift code. The server 206 could also perform a similar functionality in an automated way, either as directed by the user or based on some triggering event, like a location based confirmation.

Often, the gift code will be sold to the user at a discount off the face value of the card for an enhanced savings. For example, if the user is browsing for coupon codes to Amazon.com and finds a coupon code that will work for 15% off a purchase of a laptop computer, the server can identify an Amazon.com gift code for $100 and offer to sell that gift code to the user for $75, offering a further discount off the list price at Amazon.com. The server 206 can offer multiple compatible codes of each type to the user. For example, some coupon codes may be stackable, such as a 15% off coupon code and a free shipping coupon code. Typically, gift codes may be stacked without limits.

The server 206 can provide coupon codes for free to the user, or charge for the service and/or individual coupon codes. The server 206 can provide gift codes for free with purchase of a coupon code, for example, or charge for gift codes, although typically below their face value. This same approach can apply in the other direction as well. For example, if a user is browsing for gift codes to purchase, the server 206 can offer coupon codes in conjunction with the gift codes in order to sweeten the deal, increase the savings, and entice the user to purchase a gift code. The server 206, the gift code database 210, and/or the coupon code database 208 can include combining rules describing interactions between gift codes and coupon codes, and describing to which merchants or transaction types the codes can be applied. Based on those rules, the server 206 can determine which gift codes and/or coupon codes to present to a user. For example, the server 206 can determine a rule relating to a maximum amount of savings a user may receive at a particular merchant, such as 15% off the list price of a product the merchant offers. If a combined coupon code and gift code exceeds the maximum savings determination set forth by the rule, in this example 15%, the server 206 can cap the allowable discount at 15%. In another example, the server 206 can determine a rule that prevents users from abusing the server 206 by allowing a maximum number of purchases using gift codes and coupon codes in a specified time period from a merchant or set of merchants.

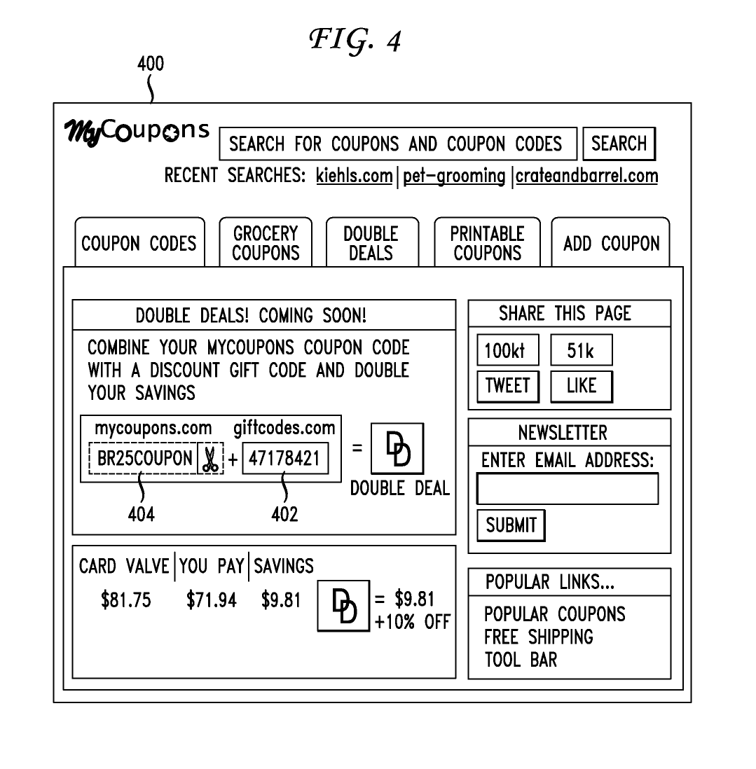

FIG. 3 illustrates a second example system architecture. The principles set forth herein can be applied to local area networks, intranets, home networks, corporate networks, and virtually any other form of network. In this architecture, the user device 302 communicates with a web server 306 via a network 304, such as the Internet or any other network. The web server 306 can provide a listing of coupon codes and associated gift codes generated by a code service 308 that accesses a gift code database 310 and a coupon code database 312. The code service 308 can be split into two separate and independent services. The web server 306 interacts with the user device 302 to display selected codes, and can allow the user to purchase a code or set of codes for use at a merchant. As set forth in FIG. 2, the user can manually enter the codes at the merchant website or other point of sale. Alternatively, as shown in FIG. 3, the web server 306 can communicate directly with the merchant 314 to facilitate application of gift codes and coupon codes to a purchase made by the user. For example, the web server 306 can redirect the user to the merchant website after the user purchases a gift code. A cookie, websocket, an AJAX call, or other communication channel can allow the web server 306 to provide the coupon and/or gift code information to the merchant to apply to a sale made by the user. The user may not even have an account with the merchant yet, may never have visited the merchant's website, etc. Alternatively, the web server 306 can gather, from the user, user account information for the merchant, and transmit the code data to the merchant so that it is associated with that user account for the next qualifying purchase automatically.

FIG. 4 illustrates a first example screenshot 400. As set forth in the screenshot 400, many users combine discounted gift codes 402 with a coupon code 404, but do it with their own research and discovery. This approach is a way to automate that code discovery process, streamline which codes can be used together, highlight the net effect of a particular combination of codes for a particular purchase, etc. In one example, the user interface 400 can provide a way for users to mix, match, and otherwise rearrange codes and view compatibility, changes in the discount percentage or amount, which perks or bonuses are available, which purchases, items, or combinations are eligible, and so forth. For example, a gift code available for purchase 402 can have a value of $81.75, and can be offered for sale to the user for $71.94, having a savings of $9.81. The user can take advantage of a double deal by using the gift code in conjunction with a coupon code for 10% off a purchase for increased savings.

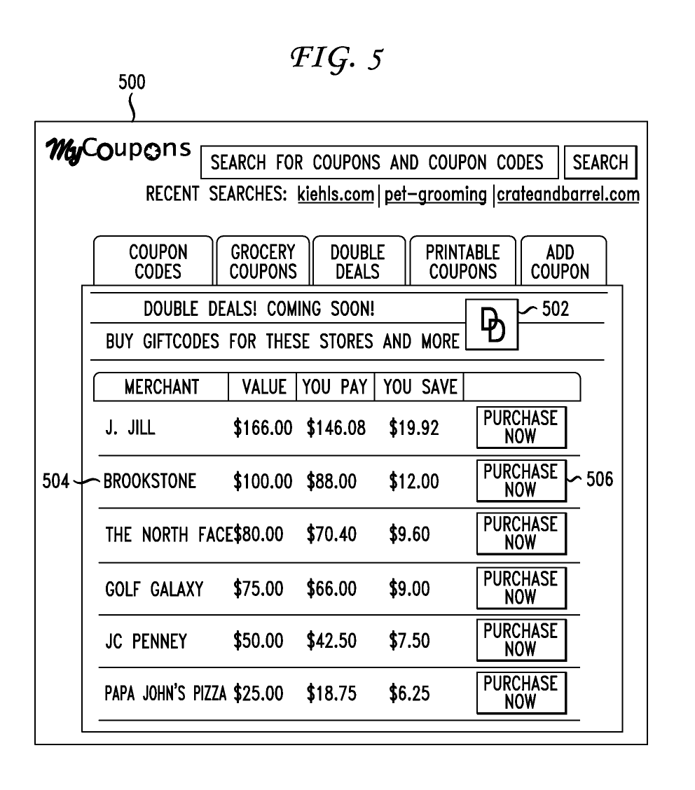

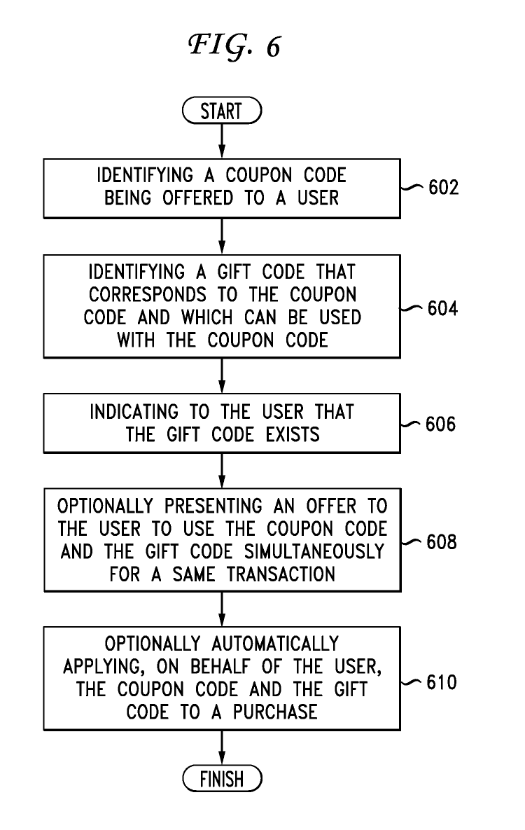

FIG. 5 illustrates a second example screenshot 500. As illustrated in the screenshot 500, this approach can consolidate bargain hunting resources into one convenient location, in order to save money on purchases online or at brick and mortar retailers. For example, the user interface 500 can display a particular logo, such as the DoubleDeals logo 502, on coupon codes for which a corresponding gift code is available, or on gift codes for which a corresponding coupon code is available. For example, the system can offer a Brookstone gift code 504 having a face value of $100 for $88, resulting in a savings of $12. The user can peruse suggested codes and select particular gift codes from the interface 500 to purchase using a one-click option 506. Alternately, the user can search for codes and filter search results based on double deals, greatest savings, gift code expiration date, user preference, user history, etc. Having disclosed some basic system components and concepts, the disclosure now turns to the exemplary method embodiment shown in FIG. 6. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

The system 100 identifies a coupon code being offered to a user (602) and a gift code (or any first code, whether associated with the user or not, having a first associated value) that corresponds to the coupon code (or any second code) having an associated second value and which can be used with the coupon code (604), and indicates to the user that the gift code exists (606). The second code can be a deal code, a discount code, a coupon code, or any combination thereof. Then the system combines the first value of the gift code with the second value of the coupon code to yield a third code that can be used for a purchase. Optionally, the third code is based on a set of combining rules governing how the system combines the gift code and the coupon code. Any of the first code, the second code and the third code can be any type of code in addition to those listed herein. In one aspect, both the first code and the second code are the same type of code. In another aspect, the first code and the second code are different types of codes. Furthermore, other codes can be also combined either at one time or at later times in the process. For example, prior to a purchase, two codes can be combined to present a reduced purchase price, but then if the user actually completes the purchase, an additional code could cause a reimbursement of some money as a final incentive to actually make the purchase.

The system can present, as the third code, an offer to the user (i.e., the offering being transmitted to the user device such as a mobile device, laptop, etc.) to use the coupon code and the gift code simultaneously for a same transaction (608), either as a free or purchased service. The system can automatically apply, on behalf of the user, the coupon code and the gift code to a purchase (610). The system can present to the user the coupon code and the gift code for application to a purchase, such as by the user copying and pasting the codes into an online cart at checkout. The system can present both codes to the user and the user can select one or both for application to the purchase.

In each example, the gift code and the coupon code can also be considered generally the first code and the second code such that any combination of these codes is possible. Further, in the combining of the first code and the second code, additional transformations of the data can occur. For example, the resulting value of the combined codes may be added to, or subtracted from each other. If the first code has a value of $1.00 and the second code has a value of $2.00, the combined value can result in $3.00, or less than $3.00 or more than $3.00 based on any number of factors. For example, if a sale is going on and the user combines the codes, then an additional 10% may be added to the combined code value to yield a code value of $3.30. If the user combines several codes then the system may query if under that circumstances, additional codes can be then added. This could result in a third code value being added to the combined code values. In this example, the fact of the combining of the codes acts as a trigger for an additional possible code or codes being added to the combination. The various codes could also be added or combined over time and based on various triggers.

In another embodiment, the first and second codes are a gift code and a companion code which the user can enter manually into an online checkout or other point of sale. An online merchant can offer coupon codes to users, and provide additional discounts to users by offering discounted gift codes. In a related embodiment, the online merchant primarily offers gift codes and can provide the coupon codes as an addition to provide enhanced savings. In yet another embodiment, the gift code and the coupon code are offered as a savings bundle.

For example, the online merchant can offer coupon codes for 15% off a purchase of $50 or more at Best Buy. In order to provide additional savings for users, the online merchant can also offer discounted gift codes, such as offering a $50 gift code for $40. In this way, a user can not only obtain the 15% off discount, but also the $10 difference between the gift code sale price and actual value, effectively receiving $50 of value for $32.50 after the $10 discount on the gift code and the 15% off of $50 which is $7.50.

When the user purchases the gift code, the online merchant can provide or deliver to the user both codes, such as via email, text message, or a web page. Then the user can copy and paste or manually enter the gift code and the coupon code at the Best Buy point of sale to obtain the discount. If the system has some level of integration with the point of sale system at Best Buy, the system can communicate the gift code and coupon code to the point of sale system so that when the user makes a purchase at Best Buy, the gift code and coupon code are automatically populated for the user.

The system can perform the following steps to implement the embodiment set forth above. The system identifies a companion code associated with a first value, wherein the companion code is at least one of a deal code, a discount code, or a coupon code. The system identifies a gift code associated with a second value, wherein the companion code, when used to make a purchase in combination with the gift code, provides a discount based on the first value for the purchase. The gift code and the companion code can be associated with the same merchant, such as Best Buy in the example above. The system offers the gift code for sale, such as via an online portal, website, or other venue. The gift code can be offered for sale at a discount price, such as offering a gift code with a value of $100 for $85. As part of offering the gift code for sale, the system can calculate a total estimated savings based on applying the companion code and the gift code to a transaction, and present the total savings to the user as a percentage saved, a dollar amount saved, or both. Upon a user purchasing the gift code, the system transmits the gift code to the user for combined use with the companion code. The gift code and the companion code can be transmitted to the user as a bundle, such as in a single email, text message, or other communication.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

I claim:

1. A method comprising:
identifying a companion code associated with a first value, wherein the companion code comprises at least one of a deal code, a discount code, and a coupon code;
identifying a gift code associated with a second value, wherein the companion code, when used to make a purchase in combination with the gift code, provides a discount based on the first value for the purchase;
offering the gift code for sale; and
upon a user purchasing the gift code, transmitting the gift code to the user for combined use with the companion code.

2. The method of claim 1, wherein the gift code and the companion code are associated with a merchant.

3. The method of claim 1, wherein the gift code and the companion code are transmitted to the user as a bundle.

4. The method of claim 1, wherein the gift code is offered for sale at a discounted price.

5. The method of claim 4, wherein offering the gift code for sale further comprises:
calculating a total savings based on applying the companion code and the gift code to a transaction; and
presenting the total savings to the user.

6. The method of claim 5, wherein the total savings is calculated based on the discounted price and the first value of the companion code.

7. The method of claim 1, wherein the gift code comprises at least one of a code, a string of characters, and a symbol.

8. The method of claim 1, wherein the companion code comprises at least one of a code, string of characters and a symbol.

9. A system comprising:
a processor; and
a computer-readable storage medium having stored therein instructions which, when executed by the processor, cause the processor to perform a method comprising:
identifying a companion code associated with a first value, wherein the companion code comprises at least one of a deal code, a discount code, and a coupon code;
identifying a gift code associated with a second value, wherein the companion code, when used to make a purchase in combination with the gift code, provides a discount based on the first value for the purchase;
offering the gift code for sale; and
upon a user purchasing the gift code, transmitting the gift code to the user for combined use with the companion code.

10. The system of claim 9, wherein the gift code and the companion code are associated with a merchant.

11. The system of claim 9, wherein the gift code and the companion code are transmitted to the user as a bundle.

12. The system of claim 9, wherein the gift code is offered for sale at a discounted price.

13. The system of claim 12, wherein offering the gift code for sale further comprises:
calculating a total savings based on applying the companion code and the gift code to a transaction; and
presenting the total savings to the user.

14. The system of claim 13, wherein the total savings is calculated based on the discounted price and the first value of the companion code.

15. The system of claim 9, wherein the gift code comprises at least one of a code, a string of characters, and a symbol.

16. The system of claim 9, wherein the companion code comprises at least one of a code, string of characters and a symbol.

17. A non-transitory computer-readable storage medium having stored therein instructions which, when executed by a processor, cause the processor to perform a method comprising:
identifying a coupon code being offered to a user;
identifying a gift code that corresponds to the coupon code and which can be used with the coupon code;
indicating to the user that the gift code exists; and
offering the gift code for sale to the user at a discounted price.

18. The non-transitory computer-readable storage medium of claim 17, storing further instructions which, when executed by the processor, cause the processor to perform a method further comprising:
offering the coupon code and the gift code to the user together as part of a same transaction.

19. The non-transitory computer-readable storage medium of claim 17, storing further instructions which, when executed by the processor, cause the processor to perform a method further comprising:
applying, on behalf of the user, the coupon code and the gift code to a purchase.

20. The non-transitory computer-readable storage medium of claim 17, storing further instructions which, when executed by the processor, cause the processor to perform a method further comprising:
presenting to the user the coupon code and the gift code for application to a purchase.
